(19) United States
(12) Patent Application Publication
(10) Pub. No.: US 2022/0267515 A1
(43) Pub. Date: Aug. 25, 2022

(54) PROCESS FOR PREPARING POLYETHER CARBONATE ALCOHOLS

(71) Applicants: Covestro Intellectual Property GmbH & Co. KG, Leverkusen (DE); Covestro Deutschland AG, Leverkusen (DE)

(72) Inventors: Aurel Wolf, Wülfrath (DE); Stefan Westhues, Leverkusen (DE); Mike Schuetze, Leverkusen (DE); Karolina Walker, Köln (DE); Christoph Guertler, Köln (US)

(21) Appl. No.: 17/628,257

(22) PCT Filed: Aug. 12, 2020
(86) PCT No.: PCT/EP2020/072576

§ 371 Date: Jan. 19, 2022

(30) Foreign Application Priority Data
Aug. 19, 2019 (EP) 19192406.7
Feb. 24, 2020 (EP) 20158917.3

(51) Int. Cl. C08G 64/30

(52) U.S. Cl. CPC C08G 64/305

(57) ABSTRACT

A process for preparing polyether carbonate alcohols by attaching cyclic propylene carbonate to an H-functional starter substance in the presence of a catalyst, characterized in that at least one compound according to formula MₙX (I) is used as a catalyst, wherein M is selected from the alkali metal cations Li⁺, Na⁺, K⁺ and Cs⁺, X is selected from the anions VO₃⁻, WO₄²⁻, MoO₄²⁻ and VO₄³⁻, n is 1, if X═VO₃⁻, n is 2, if X═WO₄²⁻ or MoO₄²⁻, and n is 3, if X═VO₄³⁻.

### CROSS REFERENCE TO RELATED APPLICATIONS

This application is a U.S. national stage application, filed under 35 U.S.C. § 371, of International Application No. PCT/EP2020/072576, which was filed on Aug. 12, 2020, and which claims priority to European Patent Application No. 20158917.3 which was filed on Feb. 24, 2020, and to European Patent Application No. 19192406.7 which was filed on Aug. 19, 2019. The contents of each are hereby incorporated by reference into this specification.

### FIELD

The present invention relates to a process for preparing polyether carbonate alcohols, preferably polyether carbonate polyols, by catalytic addition reaction of cyclic propylene carbonate (cPC) onto an H-functional starter substance.

### BACKGROUND

It is known that cyclic carbonates, for example cyclic propylene carbonate, may be used as a monomer in the preparation of polycarbonate polyols. This reaction is based on a transesterification and is performed in the presence of catalysts such as for example titanium compounds, such as titanium dioxide or titanium tetrabutoxide (EP 0 343 572), tin compounds, such as tin dioxide or dibutyltin oxide (DE 2 523 352), or alkali metal carbonates or acetates (DE 1 495 299 A1). However, in these processes the employed carbonates and alcohols are incorporated alternately to afford alternating polycarbonate polyols. These alternating polycarbonate polyols do not contain any ether groups. In addition, these catalysts have the disadvantage that at the customary reaction temperatures of 150° C. to 230° C. by-products such as ethylene glycol or propylene glycol are formed. These by-products are difficult to separate by thermal means and are therefore undesirable in the context of an economic process.

In the publication of Harris (“Harris, R F: Structural features of poly(alkylene ether carbonate) diol oligomers by capillary gas chromatography, Journal of Applied Polymer Science, 1989, 37, pp. 183-200”), poly(ethylene ether carbonate) diols are prepared by the addition of cyclic ethylene carbonate onto monoethylene glycol or diethylene glycol in the presence of various catalysts, including those based on vanadium. There is no mention of cyclic propylene carbonate in the publication by Harris.

The ring-opening polymerization of cPC is known, for example, from Soga et al. (“K. Soga, Y. Tazuke, S. Hosada, S. Ikeda: Polymerization of propylene varbonate, J. Polym. Sci., 1977, 15, pp. 219-229”). In contrast to the ring-opening polymerization of cyclic ethylene carbonate (cEC), undesirable double-bond-containing by-products are formed in the polymerization of cPC, where long reaction times of 72-100 hours and high temperatures are necessary for the polymerization (“G. Rokicki: Aliphatic cyclic carbonates and spiroorthocarbonates as monomers, Prog. Polym. Sci., 2000, 25, pp. 259-342”).

### SUMMARY

The object on which the present invention is based was therefore to reduce the formation of by-products when using cyclic propylene carbonate as a monomer for the preparation of polyether carbonate alcohols.

It has been found that, surprisingly, the technical object of the invention is achieved by a process for preparing polyether carbonate alcohols by addition reaction of cyclic propylene carbonate onto an H-functional starter substance in the presence of a catalyst, characterized in that

the catalyst used is at least one compound according to the formula

MₙX (I),

wherein

M is selected from the alkali metal cations Li⁺, Na⁺, K⁺ and Cs⁺,

X is selected from the anions VO₃⁻, WO₄²⁻, MoO₄²⁻ and VO₄³⁻

n is 1, if X═VO₃⁻,

n is 2, if X═WO₄²⁻ or MoO₄²⁻,

n is 3, if X═VO₄³⁻.

### DETAILED DESCRIPTION

The process may comprise first initially charging the reactor with an H-functional starter substance and cyclic propylene carbonate. It is also possible to initially charge the reactor with only a subamount of the H-functional starter substance and/or a subamount of the cyclic propylene carbonate. The amount of catalyst required for the ring-opening polymerization is then optionally added to the reactor. The sequence of addition is not critical. It is also possible to charge the reactor first with the catalyst and then with an H-functional starter substance and cyclic propylene carbonate. It is alternatively also possible first to suspend the catalyst in an H-functional starter substance and then to charge the reactor with the suspension.

The catalyst is preferably used in an amount such that the catalyst content in the resulting reaction product is 10 to 50 000 ppm, particularly preferably 20 to 30 000 ppm, and most preferably 50 to 20 000 ppm. The catalyst content is preferably determined by elemental analysis by inductively coupled plasma optical emission spectroscopy (ICP-OES).

In a preferred embodiment, inert gas (for example argon or nitrogen) is introduced into the resulting mixture of (a) a subamount of H-functional starter substance, (b) catalyst and (c) cyclic propylene carbonate at a temperature of 20° C. to 120° C., particularly preferably of 40° C. to 100° C.

In an alternative preferred embodiment, the resulting mixture of (a) a subamount of H-functional starter substance, (b) catalyst and (c) cyclic propylene carbonate is subjected at least once, preferably three times, at a temperature of 20° C. to 120° C., particularly preferably of 40° C. to 100° C., to 1.5 bar to 10 bar (absolute), particularly preferably 3 bar to 6 bar (absolute), of an inert gas (for example argon or nitrogen) and then the gauge pressure is reduced in each case to about 1 bar (absolute).

The catalyst may be added in solid form or as a suspension in cyclic propylene carbonate, in H-functional starter substance or in a mixture thereof.

In a further preferred embodiment, in a first step a subamount of the H-functional starter substances and cyclic propylene carbonate are initially charged and in a subsequent second step the temperature of the subamount of H-functional starter substance and of the cyclic propylene carbonate is brought to 40° C. to 120° C., preferably 40° C. to 100° C., and/or the pressure in the reactor is reduced to less than 500 mbar, preferably 5 mbar to 100 mbar, wherein optionally an inert gas stream (for example of argon or nitrogen) is applied and the catalyst is added to the subamount of H-functional starter substance in the first step or immediately thereafter in the second step.

The resulting reaction mixture is then heated at a temperature of 130° C. to 230° C., preferably 140° C. to 200° C., particularly preferably 160° C. to 190° C., wherein an inert gas stream (for example of argon or nitrogen) may optionally be passed through the reactor. The reaction is continued until no more gas evolution is observed at the established temperature. The reaction may likewise be carried out under pressure, preferably at a pressure of 50 mbar to 100 bar (absolute), particularly preferably 200 mbar to 50 bar (absolute), particularly preferably 500 mbar to 30 bar (absolute).

If the reactor has only been initially charged with a subamount of H-functional starter substance and/or a subamount of cyclic propylene carbonate, the metered addition of the remaining amount of H-functional starter substance and/or cyclic propylene carbonate into the reactor is carried out continuously. It is possible to effect metered addition of the cyclic propylene carbonate at a constant metering rate or to increase or lower the metering rate gradually or stepwise or to add the cyclic propylene carbonate portionwise. The cyclic propylene carbonate is preferably added to the reaction mixture at a constant metering rate. The metered addition of the cyclic propylene carbonate or of the H-functional starter substances may be effected simultaneously or sequentially in each case via separate metering points (addition points) or via one or more metering points where metered addition of the H-functional starter substances may be effected individually or as a mixture.

In addition to the cyclic propylene carbonate, the process may optionally employ further cyclic carbonate at a proportion of not more than 20% by weight, preferably not more than 10% by weight, particularly preferably not more than 5% by weight, based in each case on the sum of the total weight of cyclic carbonate used. The further cyclic carbonate used is preferably ethylene carbonate. However it is very particularly preferable to use only cyclic propylene carbonate.

The polyether carbonate alcohols may be prepared in a batch, semi-batch or continuous process. It is preferable when the polyether carbonate alcohols are prepared in a continuous process which comprises both a continuous polymerization and a continuous addition of the H-functional starter substance.

The invention therefore also provides a process, wherein H-functional starter substance, cyclic propylene carbonate and catalyst are continuously metered into the reactor and wherein the resulting reaction mixture (containing the reaction product) is continuously removed from the reactor. The catalyst is preferably suspended in H-functional starter substance and added continuously.

The term “continuously” used here can be defined as the mode of addition of a relevant catalyst or reactant such that an essentially continuously effective concentration of the catalyst or the reactant is maintained. The feeding of the catalyst and the reactants may be effected in a truly continuous manner or in relatively tightly spaced increments. Equally, continuous starter addition may be effected in a truly continuous manner or in increments. There would be no departure from the present process in adding a catalyst or reactants incrementally such that the concentration of the materials added drops essentially to zero for a period of time before the next incremental addition. However, it is preferable for the catalyst concentration to be kept substantially at the same concentration during the main portion of the course of the continuous reaction, and for starter substance to be present during the main portion of the polymerization process. An incremental addition of catalyst and/or reactant which does not substantially influence the nature of the product is nevertheless “continuous” in that sense in which the term is being used here. It is possible, for example, to provide a recycling loop in which a portion of the reacting mixture is recycled to a prior point in the process, thus smoothing out discontinuities caused by incremental additions.

H-Functional Starter Substance

Suitable H-functional starter substances (starters) that may be used are compounds having alkoxylation-active H atoms which have a number-average molecular weight according to DIN55672-1 of up to 10 000 g/mol, preferably up to 5000 g/mol and particularly preferably up to 2500 g/mol.

Alkoxylation-active groups having active H atoms are, for example, —OH, —NH₂ (primary amines), —NH— (secondary amines), —SH and —CO₂H, preferably —OH, —NH₂ and —CO₂H, particularly preferably —OH. H-functional starter substances used are, for example, one or more compounds selected from the group consisting of mono- or polyhydric alcohols, polyfunctional amines, polyfunctional thiols, amino alcohols, thio alcohols, hydroxy esters, polyether polyols, polyester polyols, polyester ether polyols, polyether carbonate polyols, polycarbonate polyols, polycarbonates, polyethyleneimines, polyetheramines, polytetrahydrofurans (e.g. PolyTHF® from BASF), polytetrahydrofuran amines, polyether thiols, polyacrylate polyols, castor oil, the mono- or diglyceride of ricinoleic acid, monoglycerides of fatty acids, chemically modified mono-, di- and/or triglycerides of fatty acids, and C1-C24 alkyl fatty acid esters containing an average of at least 2 OH groups per molecule and water. The C1-C24 alkyl fatty acid esters containing an average of at least 2 OH groups per molecule are for example commercial products such as Lupranol Balance® (from BASF AG), Merginol® products (from Hobum Oleochemicals GmbH), Sovermol® products (from Cognis Deutschland GmbH & Co. KG) and Soyol®™ products (from USSC Co.). Monofunctional starter substances used may be alcohols, amines, thiols and carboxylic acids. Monofunctional alcohols used may be: methanol, ethanol, 1-propanol, 2-propanol, 1-butanol, 2-butanol, tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, dodecanol, tetradecanol, hexadecanol, octadecanol, eicosanol, phenol, 2-hydroxybiphenyl, 3-hydroxybiphenyl, 4-hydroxybiphenyl, 2-hydroxypyridine, 3-hydroxypyridine, 4-hydroxypyridine. Suitable monofunctional amines include: butylamine, tert-butylamine, pentylamine, hexylamine, aniline, aziridine, pyrrolidine, piperidine, morpholine. Monofunctional thiols used may be: ethanethiol, 1-propanethiol, 2-propanethiol, 1-butanethiol, 3-methyl-1-butanethiol, 2-butene-1-thiol, thiophenol. Carboxylic acids include: formic acid, acetic acid, propionic acid, butyric acid, acrylic acid, oxalic acid, malonic acid, succinic acid, glutaric acid, adipic acid, pimelic acid, aromatic carboxylic acids such as benzoic acid, terephthalic acid, tetrahydrophthalic acid, phthalic acid or isophthalic acid, fatty acids such as stearic acid, palmitic acid, oleic acid, linoleic acid or linolenic acid.

Polyhydric alcohols suitable as H-functional starter substances are, for example, dihydric alcohols (for example ethylene glycol, diethylene glycol, propylene glycol, dipropylene glycol, propane-1,3-diol, butane-1,4-diol, butene-1,4-diol, butyne-1,4-diol, neopentyl glycol, pentane-1,5-diol, methylpentanediols (for example 3-methylpentane-1,5-diol), hexane-1,6-diol; octane-1,8-diol, decane-1,10-diol, dodecane-1,12-diol, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol and polybutylene glycols); trihydric alcohols (for example trimethylolpropane, glycerol, trishydroxyethyl isocyanurate, castor oil); tetrahydric alcohols (for example pentaerythritol); polyalcohols (for example sorbitol, hexitol, sucrose, starch, starch hydrolyzates, cellulose, cellulose hydrolyzates, hydroxy-functionalized fats and oils, in particular castor oil), and all modification products of these aforementioned alcohols with different amounts of ε-caprolactone.

The H-functional starter substance may also be selected from the substance class of the polyether polyols having a molecular weight Mₙ according to DIN55672-1 in the range from 18 to 8000 g/mol and a functionality of 2 to 3. Preference is given to polyether polyols formed from repeating ethylene oxide and propylene oxide units, preferably having a proportion of propylene oxide units of 35% to 100%, particularly preferably having a proportion of propylene oxide units of 50% to 100%. These may be random copolymers, gradient copolymers, alternating copolymers or block copolymers of ethylene oxide and propylene oxide.

The H-functional starter substance may also be selected from the substance class of the polyester polyols. The polyester polyols used are at least difunctional polyesters. Polyester polyols preferably consist of alternating acid and alcohol units. Acid components employed include, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Alcohol components employed include, for example, ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol or mixtures of the alcohols mentioned. Employing dihydric or polyhydric polyether polyols as the alcohol component affords polyester ether polyols which can likewise serve as starter substances for preparation of the polyether carbonate alcohols.

In addition, H-functional starter substance used may be polycarbonatediols which are prepared, for example, by reaction of phosgene, dimethyl carbonate, diethyl carbonate or diphenyl carbonate and difunctional alcohols or polyester polyols or polyether polyols. Examples of polycarbonates may be found, for example, in EP-A 1359177. In a further embodiment of the invention, polyethercarbonate polyols may be used as H-functional starter substances. More particularly, polyether carbonate polyols obtainable by the process according to the invention described here are used. To this end, these polyethercarbonate polyols used as H-functional starter substance are prepared beforehand in a separate reaction step.

The H-functional starter substance generally has a functionality (i.e. number of polymerization-active H atoms per molecule) of 1 to 8, preferably of 1 to 3. The H-functional starter substance is used either individually or as a mixture of at least two H-functional starter substances.

It is particularly preferable when the H-functional starter substance is at least one of compounds selected from the group consisting of water, ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, pentaerythritol, sorbitol, polyether carbonate polyols having a molecular weight Mₙ according to DIN55672-1 in the range from 150 to 8000 g/mol with a functionality of 2 to 3, and polyether polyols having a molecular weight Mₙ according to DIN55672-1 in the range from 150 to 8000 g/mol and a functionality of 2 to 3.

The H-functional starter substance is preferably selected such that the polyether carbonate alcohol obtained is a polyether carbonate polyol, i.e. a polyether carbonate alcohol having a functionality of 2 or more.

Catalyst

According to the invention, the catalyst used is at least one compound according to the formula

MₙX (I),

wherein

M is selected from the alkali metal cations Li⁺, Na⁺, K⁺ and Cs⁺,

X is selected from the anions VO₃⁻, WO₄²⁻, MoO₄²⁻ and VO₄³⁻,

n is 1, if X═VO₃⁻,

n is 2, if X═WO₄²⁻ or MoO₄²⁻

n is 3, if X═VO₄³⁻,

The anion X of the catalyst is preferably VO₃⁻ or VO₄³⁻. The alkali metal cation M used is Li⁺, Na⁺, K⁺ or Cs⁺, particularly preferably K⁺ or Cs⁺.

Catalysts used for the invention are preferably Li₂WO₄, Na₂WO₄, K₂WO₄, Cs₂WO₄, Li₂MoO₄, Na₂MoO₄, K₂MoO₄, Cs₂MoO₄, Li₃VO₄, Na₃VO₄, K₃VO₄, Cs₃VO₄, LiVO₃, NaVO₃, KVO₃ and CsVO₃, particularly preferably K₃VO₄, Cs₃VO₄, KVO₃ and CsVO₃.

The polyether carbonate alcohols obtained by the process according to the invention may be subjected to further processing for example by reaction with di- and/or polyisocyanates to afford polyurethanes.

Other possible application are in washing detergent and cleaning product formulations, for example for textile or surface cleaning, drilling fluids, fuel additives, ionic and non-ionic surfactants, dispersants, lubricants, process chemicals for paper or textile production, cosmetic formulations, for example in skin or sun protection cream or hair care products.

### EXPERIMENTAL

Experimentally determined OH numbers were determined according to the specification of DIN 53240-2 (November 2007).

The molecular weight Mₙ the resulting polyether carbonate alcohols were determined by means of gel permeation chromatography (GPC). The procedure according to DIN 55672-1 (August 2007): “Gel Permeation Chromatography, Part 1—Tetrahydrofuran as Eluent” was followed and polystyrene samples of known molar mass were used for calibration.

The proportion of CO₂ incorporated in the resulting polyether carbonate alcohol (CO₂ content) was determined by ¹H-NMR spectroscopy (Bruker, AV III HD 600, 600 MHz; pulse program zg30, waiting time dl: 10 s, 64 scans). Each sample was dissolved in deuterated chloroform. The relevant resonances in the ¹H-NMR spectrum (based on TMS=0 ppm) are as follows:

For olefinic (allyl alcohol/ether groups) formed, the signals at 6.01-5.88 ppm and 5.37-5.10 ppm are used (the sum of both corresponds to an integral of 3 protons). The remaining monomeric propylene carbonate (signal at 1.51-1.49 ppm), for carbon dioxide incorporated into the polyether carbonate alcohol (resonances at 1.31-1.27 and possibly), polyether polyol (i.e without incorporated carbon dioxide) with resonances at 1.14-1.10 ppm.

The mole fraction of the carbonate incorporated in the polymer in the reaction mixture is calculated by formula (II) as follows, using the following abbreviations:
F (6.01-5.88)=area of resonance at 6.01-5.88 ppm for olefinic allyl alcohol/ether groups (1 proton)
F (5.37-5.10)=area of resonance at 5.37-5.10 ppm for olefinic allyl alcohol/ether groups (2 protons)
F (1.51-1.49)=area of the resonance at 1.51-1.49 ppm for cyclic carbonate (corresponds to 3 protons)
F (1.31-1.27)=area of the resonance at 1.31-1.27 ppm for polyether carbonate alcohol (corresponds to 3 protons)
F (1.14-1.10)=area of resonance at 1.14-1.10 ppm for polyether polyol (corresponds to 3 protons)

Taking account of the relative intensities, according to the following formula (II), a conversion was made to mol % for the polymer-bound carbonate (“linear carbonate” LC) in the reaction mixture:

$$L {C}_{mo l \%} = \frac{F ( 1.31 - 1.27 )}{\begin{matrix}\begin{matrix}F ( 1.51 - 1.49 ) + F ( 1.31 - 1.27 ) + \\ F ( 1.14 - 1.1 ) +\end{matrix} \\ F ( 6.01 - 5.88 ) + F ( 5.37 - 5.1 )\end{matrix}} \cdot 100 \% \qquad ( II )$$

The proportion by weight (in % by weight) of polymer-bound carbonate (LC′) in the reaction mixture was calculated by formula (III):

$${LC}_{g e w . \%}^{′} = \frac{[ F ( 1.31 - 1.27 ) ] \cdot 102}{N} \cdot 100 \% \qquad ( III )$$

wherein the value of N (“denominator” N) is calculated according to formula (IV):

N=(F(1.51−1.49)+F(1.51−1.49))·102+F(1.14−1.10)·58+(F(6.01−5.88)+F(5.37−5.10))*44 (IV)

The factor 102 results from the sum of the molar masses of CO₂ (molar mass 44 g/mol) and that of propylene oxide (molar mass 58 g/mol). The factor 44 results from the molar mass of allyl alcohol (44 g/mol)

The proportion by weight (in % by weight) of CO₂ in the polyether carbonate alcohol was calculated according to formula (V):

$${CO}_{{2}_{g e w . \%}} = {LC}_{g e w . \%} \cdot \frac{44}{102} \qquad ( V )$$

The molar content (in mol %) of olefinic products (allyl alcohol/ether products) (OL) was determined according to the following formula (VI)

$${OL}_{m ol \%} = \frac{F ( 6.01 - 5.88 ) + F ( 5.37 - 5.1 )}{\begin{matrix}F ( 1.51 - 1.49 ) + F ( 1.31 - 1.27 ) + \\ F ( 1.14 - 1.1 ) + \\ F ( 6.01 - 5.88 ) + F ( 5.37 - 5.1 )\end{matrix}} \cdot 100 \% \qquad ( V1 )$$

The proportion by weight (in % by weight) of olefinic products (allyl alcohol/ether products) (OL′) in the reaction mixture was calculated according to formula (VII),

$${OL}_{g e w . \%}^{′} = \frac{[ F ( 6.01 - 5.88 ) + F ( 5.37 - 5.1 ) ] 44}{N} \cdot 100 \qquad ( VII )$$

wherein the value of N (“denominator” N) is calculated according to formula (IV).

The non-polymer constituents of the reaction mixture (i.e. unconverted cyclic propylene carbonate) were mathematically eliminated to determine the composition based on the polymer proportion (consisting of polyether carbonate alcohol constructed from starter and cyclic propylene carbonate) from the values of the composition of the reaction mixture. The proportion by weight of the carbonate repeating units in the polyether carbonate alcohol was converted to a proportion by weight of carbon dioxide using the factor F=44/(58+44) (see formula V). The FIGURE for the CO₂ content in the polyether carbonate alcohol (“CO₂ incorporated”; see examples which follow) is normalized to the polyether carbonate alcohol molecule formed in the ring-opening polymerization.

Raw Materials Employed:

All chemicals listed were purchased from the cited manufacturer in the specified purity and used for the synthesis of polyether carbonate alcohols without further treatment.

| | |
|---|---|
| Sodium orthovanadate (Na₃VO₄): | Sigma-Aldrich 99.98% |
| Potassium orthovanadate (K₃VO₄): | ABCR 99.9% |
| Cesium orthovanadate (Cs₃VO₄): | ABCR 99.9% |
| Potassium metavanadate (KVO₃): | Sigma-Aldrich 98% |
| Cesium metavanadate (CsVO₃): | Sigma-Aldrich >99.9% |
| Potassium carbonate (K₂CO₃): | Bernd Kraft >99% |
| Cesium carbonate (Cs₂CO₃): | Sigma-Aldrich >99.9% |
| Cyclich propylene carbonate (cPC): | Sigma-Aldrich 99% |
| 1,6-Hexanediol: | Sigma-Aldrich 99% |
| Ammonium metavanadate (NH₄VO₃): | ABCR >99.9% |
| Calcium metavanadate (Ca(VO₃)₂): | ABCR 99.8% |
| Sodium stannate trihydrate (Na₂SnO₃•3H₂O): | Sigma-Aldrich >98% |

### Example 1: Preparation of Polyether Carbonate Alcohols by Ring-Opening Polymerization of Cyclic Propylene Carbonate in the Presence of Hexane-1,6-Diol as Starter and Na₃VO₄ as Catalyst

A 500 mL four-necked glass flask was provided with a reflux condenser, KPG stirrer, temperature probe, nitrogen feed and gas outlet/discharge with pressure relief valve. 200 g of cyclic propylene carbonate, 34.25 g of hexane-1,6-diol and 1.8 g of Na₃VO₄ were then weighed in. For 30 minutes 10 L/h of nitrogen were introduced and the suspension stirred at 300 rpm. The suspension was then heated stepwise to 180° C. The resulting gas stream was discharged through a bubble counter downstream of the reflux condenser.

The reaction mixture was held at the established temperature until the gas evolution ceased.

The CO₂ proportion incorporated in the polyether carbonate alcohol, the olefin/allyl alcohol/ether content was determined by ¹H-NMR spectroscopy by the methods described above. The molecular weight was determined by gel permeation chromatography.

The properties of the resulting polyether ester carbonate alcohol are shown in table 1.

### Example 2: Preparation of Polyether Carbonate Alcohols by Ring-Opening Polymerization of Cyclic Propylene Carbonate in the Presence of Hexane-1,6-Diol as Starter and K₃VO₄ as Catalyst

The reaction was carried out analogously to example 1 with the exception that 2.3 g of K₃VO₄ were used as catalyst instead of Na₃VO₄.

The properties of the resulting polyether carbonate alcohol are shown in Table 1.

### Example 3: Preparation of Polyether Carbonate Alcohols by Ring-Opening Polymerization of Cyclic Propylene Carbonate in the Presence of Hexane-1,6-Diol as Starter and Cs₃VO₄ as Catalyst

The reaction was carried out analogously to example 1 with the exception that 5.3 g of Cs₃VO₄ were used as catalyst instead of Na₃VO₄.

The properties of the resulting polyether carbonate alcohol are shown in Table 1.

### Example 4: Preparation of Polyether Carbonate Alcohols by Ring-Opening Polymerization of Cyclic Propylene Carbonate in the Presence of Hexane-1,6-Diol as Starter and NaVO₃ as Catalyst

The reaction was carried out analogously to example 1 with the exception that 1.2 g of NaVO₃ were used as catalyst instead of Na₃VO₄.

The properties of the resulting polyether carbonate alcohol are shown in Table 1.

### Example 5: Preparation of Polyether Carbonate Alcohols by Ring-Opening Polymerization of Cyclic Propylene Carbonate in the Presence of Hexane-1,6-Diol as Starter and KVO₃ as Catalyst

The reaction was carried out analogously to Example 1, with a total of 32.9 g of hexane-1,6-diol as H-functional starter substance and 1.4 g of KVO₃ were used as catalyst instead of Na₃VO₄.

The properties of the resulting polyether carbonate alcohol are shown in Table 1.

### Example 6: Preparation of Polyether Carbonate Alcohols by Ring-Opening Polymerization of Cyclic Propylene Carbonate in the Presence of Hexane-1,6-Diol as Starter and CsVO₃ as Catalyst

The reaction was carried out analogously to Example 1, with the exception that 2.3 g of CsVO₃ were used as catalyst instead of Na₃VO₄.

The properties of the resulting polyether carbonate alcohol are shown in Table 1.

### Example 7: Preparation of Polyether Carbonate Alcohols by Ring-Opening Polymerization of Cyclic Propylene Carbonate in the Presence of Diethylene Glycol as Starter and Sodium Stannate Trihydrate as Catalyst

The reaction was carried out analogously to Example 1, with a total of 150 g of cPC, 7.7 g of diethylene glycol as H-functional starter substance and 1.6 g of Na₂SnO₃.3H₂O were used as catalyst instead of Na₃VO₄.

The properties of the resulting polyether carbonate alcohol are shown in Table 1.

### Example 8: Preparation of Polyether Carbonate Alcohols by Ring-Opening Polymerization of Cyclic Propylene Carbonate in the Presence of Hexane-1,6-Diol as Starter and K₂CO₃ as Catalyst

The reaction was carried out analogously to Example 1, with a total of 34.7 g of hexane-1,6-diol as H-functional starter substance and 1.4 g of K₂CO₃ were used as catalyst instead of Na₃VO₄.

The properties of the resulting polyether carbonate alcohol are shown in Table 1.

### Example 9: Preparation of Polyether Carbonate Alcohols by Ring-Opening Polymerization of Cyclic Propylene Carbonate in the Presence of Hexane-1,6-Diol as Starter and Cs₂CO₃ as Catalyst

The reaction was carried out analogously to Example 1, with a total of 34.7 g of hexane-1,6-diol as H-functional starter substance and 3.2 g of Cs₂CO₃ were used as catalyst instead of Na₃VO₄.

The properties of the resulting polyether carbonate alcohol are shown in Table 1.

### Example 10: Preparation of Polyether Carbonate Alcohols by Ring-Opening Polymerization of Cyclic Propylene Carbonate in the Presence of Hexane-1,6-Diol as Starter and NH₄VO₃ as Catalyst

The reaction was carried out analogously to Example 1, with a total of 34.7 g of hexane-1,6-diol as H-functional starter substance and 1.2 g of NH₄VO₃ were used as catalyst instead of Na₃VO₄.

No polyether carbonate alcohol was obtained.

### Example 11: Preparation of Polyether Carbonate Alcohols by Ring-Opening Polymerization of Cyclic Propylene Carbonate in the Presence of Hexane-1,6-Diol as Starter and Ca(VO₃)₂ as Catalyst

The reaction was carried out analogously to Example 1, with a total of 34.7 g of hexane-1,6-diol as H-functional starter substance and 2.3 g of Ca(VO₃)₂ were used as catalyst instead of Na₃VO₄.

No polyether carbonate alcohol was obtained.

TABLE 1

| | | | Olefin/ | | |
|---|---|---|---|---|---|
| | | CO₂ | Allyl | Molecular | Conversion |
| Exam- | | [% by | [% by | weight Mₙ | (cPC) |
| ple | Catalyst | wt.] | wt.] | [g/mol] | [%] |
| 1 | Na₃VO₄ | 20 | 0 | 419 | 87 |
| 2 | K₃VO₄ | 17 | 0 | 448 | >99 |
| 3 | Cs₃VO₄ | 19 | 0 | 400 | >99 |
| 4 | NaVO₃ | 18 | 0 | 408 | 89 |
| 5 | KVO₃ | 15 | 0 | 436 | >99 |
| 6 | CsVO₃ | 16 | 0 | 452 | >99 |
| 7* | Na₂SnO₃•3H₂O | 8 | 16 | 238 | 87 |
| 8* | K₂CO₃ | 8 | 4 | 383 | 99 |
| 9* | Cs₂CO₃ | 7 | 12 | 363 | >99 |

| | | |
|---|---|---|
| 10* | NH₄VO₃ | No product formed |
| 11* | Ca(VO₃)₂ | No product formed |

*comparative example

As can be seen in Table 1, the catalysts used in Examples 1 to 8 result in the addition of cyclic propylene carbonate onto an H-functional starter substance, where the use of NH₄VO₃ and Ca(VO₃)₂ as catalyst (Examples 9 and 10) do not result in any polyether carbonate alcohol. The catalysts according to the invention result in an elevated incorporation of cyclic propylene carbonate in the polyether carbonate alcohols of Examples 1 to 5. In addition, the use of non-inventive catalysts leads to the formation of olefin (allyl alcohol/ether) by-products in the preparation of polyether carbonate alcohols via the addition of cyclic propylene carbonate onto H-functional starter substance. Furthermore, the use of non-inventive catalysts results in polyether carbonate alcohols having lower molecular weights (Examples 6, 7 and 8) due to the secondary reactions of the cyclic propylene carbonate that occur.

In a preferred embodiment of the invention, K⁺ or Cs⁺ are used as alkali metal cation M for the catalysts according to the invention. The use of catalysts of this preferred embodiment results in a higher conversion of cPC in the process.

1. A process for preparing polyether carbonate alcohols by adding cyclic propylene carbonate onto an H-functional starter substance in the presence of a catalyst, wherein the catalyst used is at least one compound according to the formula
MₙX (I),
wherein
M is selected from the alkali metal cations Li⁺, Na⁺, K⁺ and Cs⁺,
X is selected from the anions VO₃⁻, WO₄²⁻, MoO₄²⁻ and VO₄³⁻,
n is 1, if X═VO₃⁻,
n is 2, if X═WO₄²⁻ or MoO₄²⁻, and
n is 3, if X═VO₄³⁻.

2. The process as claimed in claim 1, wherein X in formula (I) is VO₃₋ or VO₄³⁻.

3. The process as claimed in claim 1, wherein M in formula (I) is K⁺ or Cs⁺.

4. The process as claimed in claim 1, wherein the catalyst according to formula (I) is at least one compound selected from the group consisting of K₃VO₄, Cs₃VO₄, KVO₃ and CsVO₃.

5. The process as claimed in claim 1, wherein the addition reaction of the cyclic propylene carbonate onto an H-functional starter substance is carried out at a temperature of 130° C. to 200° C.

6. The process as claimed in claim 1, wherein the H-functional starter substance has a number-average molecular weight according to DIN55672-1 of up to 10000 g/mol.

7. The process as claimed in claim 1, wherein the H-functional starter substance is at least one compound selected from the group consisting of water, ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, pentaerythritol, sorbitol, polyether carbonate polyols having a molecular weight Mₙ in the range from 150 to 8000 g/mol with a functionality of 2 to 3, and polyether polyols having a molecular weight Mₙ according to DIN55672-1 in the range from 150 to 8000 g/mol and a functionality of 2 to 3.

8. The process as claimed in claim 1, wherein the catalyst is present at a proportion of 10 to 50000 ppm, based on the resulting reaction product.

9. The process as claimed in claim 1, wherein a further cyclic carbonate is used at a proportion of at most 20% by weight, based on the sum of the total weight of cyclic carbonate used.

10. The process as claimed in claim 1, wherein no further cyclic carbonate is used.

11. The process as claimed in claim 1, wherein the H-functional starter substance, cyclic propylene carbonate and catalyst are continuously metered into the reactor.

12. The process as claimed in claim 11, wherein the resulting product is continuously removed from the reactor.

13. A polyether carbonate alcohol obtained by a process as claimed in claim 1.

14. A method comprising producing polyurethanes utilizing the polyether carbonate alcohol as claimed in claim 13.

15. Washing detergent and cleaning product formulations, drilling fluids, fuel additives, ionic and non-ionic surfactants, dispersants, lubricants, process chemicals for paper or textile production, and cosmetic formulations comprising the polyether carbonate alcohol as claimed in claim 13.

16. The process as claimed in claim 5, wherein the addition reaction of the cyclic propylene carbonate onto an H-functional starter substance is carried out at a temperature of 140° C. to 190° C.

17. The process as claimed in claim 6, wherein the H-functional starter substance has a number-average molecular weight according to DIN55672-1 of up to 2500 g/mol.

18. The process as claimed in claim 8, wherein the catalyst is present at a proportion of 50 to 20000 ppm, based on the resulting reaction product.

19. The process as claimed in claim 2, wherein M in formula (I) is K⁺ or Cs⁺.
